(19) United States
(12) Patent Application Publication
(10) Pub. No.: US 2017/0177729 A1
(43) Pub. Date: Jun. 22, 2017

(54) SEARCH ENGINE AND LINK-BASED RANKING ALGORITHM FOR THE SEMANTIC WEB

(71) Applicant: BRITISH TELECOMMUNICATIONS PUBLIC LIMITED COMPANY, London (GB)

(72) Inventors: Alistair K DUKE, London (GB); Nicholas J DAVIES, London (GB); Temitope OMITOLA, London (GB)

(21) Appl. No.: 15/129,973

(22) PCT Filed: Mar. 27, 2015
(86) PCT No.: PCT/GB2015/050946

§ 371 Date: Sep. 28, 2016

(30) Foreign Application Priority Data
Mar. 28, 2014 (EP) 14250054.5

(51) Int. Cl. G06F 17/30

(52) U.S. Cl. CPC G06F 17/30867; G06F 17/3053

(57) ABSTRACT

A dataset ranking procedure for use in a hyperdata search engine is disclosed. A problem with known hyperdata search engines is they rank the datasets in a way that leads to prominence being given in search results to unimportant datasets. The hyperdata search engine disclosed here addresses this problem by giving extra credence to any dataset which includes the original definition of a resource which is referred to in a resource definition in another dataset. In this way, datasets which the authors of other datasets choose to refer to in their own resource definitions are given greater prominence in the results provided by a hyperdata search engine, providing a user with what he requires in order to more quickly find a dataset which provides useful information relating to his search query. In some embodiments, the reference to another dataset is found in a relationship statement including a subject, predicate and object, and the amount of extra credence given by virtue of the reference depends on the predicate found in the relationship statement. In refinements of those embodiments, the use of a more popular predicate in the relationship statements leads to the reference being given more weight.

The present invention relates to a search engine for finding hyperdata datasets relevant to a user's query. It has particular utility in relation to finding datasets linked by hyperdata links.

Given the success of the hyperlinked World-Wide Web, there is a movement which encourages the publication of hyperdata (i.e. data which includes links to other data). One example of this is so-called Linked Data. Hyperdata can be distinguished from hypertext (and more broadly hypermedia) because hyperdata includes information about the nature of the link between two resources which goes beyond the mere existence of a link between the two resources.

The prevalent example of hyperdata is the semantic web. Linked Data refers to the use of a set of known standard technologies to create the semantic web.

Firstly, Linked Data encourages the representation of knowledge using the Resource Description Framework data model. That data model specifies that knowledge should be represented as subject-predicate-object triples, where each of the subject and object represent resources and the predicate is indicative of the nature of the relationship between the resources.

Secondly, Linked Data uses Universal Resource Identifiers (URIs) and the Hypertext Transfer Protocol (HTTP). Subject-predicate-object statements can be made about resources using names for those resources. Namespaces can be defined to ensure that the names used to identify resources in datasets are globally unique. Linked Data uses URIs as globally unique names. URIs are akin to URLs (Uniform Resource Locators) but are used to identify non-information resources rather than web pages (the idea is that tangible physical entities might be given a URI). According to the Linked Data principles, when an application or user requests a URI using the HTTP protocol, they should be provided with semantically marked-up data describing the non-information resource to which that URI is attributed. This is known as dereferencing the URI.

Swoogle is a crawler-based indexing and retrieval system for the semantic web. The search engine is described in the paper, “Swoogle: A Search and Metadata Engine for the Semantic Web”, in 2004 by Li Ding et al, in the proceedings of the thirteenth ACM international conference on Information and knowledge management (CIKM '04), at pages 652-659. Swoogle finds Semantic Web documents and extracts any references to other semantic web documents. It then runs a modified PageRank algorithm which places greater weight on inter-ontology links which must be followed in order to understand the semantic web document. Assertions in the semantic web document about an individual defined in another semantic web document are considered to be an example of a link between the two semantic web documents.

In a paper entitled “DING! Dataset Ranking using Formal Descriptions” presented in the proceedings of the Linked Data on the Web workshop in April 2009, Nickolai Toupikov et al present a method of ranking datasets based on formal descriptions of the datasets' characteristics. DING uses link analysis to rank datasets, and considers the types of the relationships in its link analysis. In particular, different relation types are given different weights in accordance with an automatic weighting scheme. DING proposes using a TF-IDF (Term Frequency-Inverse Document Frequency) measure to weight different relation types. This measure is used in information retrieval when finding keywords which best characterise a given document—the TF-IDF measure is higher for terms which are found in the document, but are rare in the document collection to which the document belongs. It follows that DING tends to de-emphasise the predicates most commonly used in links between datasets.

According to a first aspect of the present invention, there is provided a method of operating a search engine to select, from a plurality of hyperdata datasets, one or more hyperdata datasets which are likely to contain information relevant to a user query, each hyperdata dataset including a plurality of statements about resources, said method comprising:

finding, in each of said hyperdata datasets, relationship statements which define a resource with reference to another resource defined in another dataset, said relationship statements including a relationship element indicative of the nature of the relationship between said resource and said other resource;
scoring each hyperdata dataset by accumulating contributions to a score for the hyperdata dataset, wherein the hyperdata dataset earns a contribution to its score when a relationship statement in another dataset refers to a resource defined in the hyperdata dataset being scored, wherein the amount of said contribution depends upon the relationship element in said relationship statement, the amount of said contribution being higher for more commonly used relationship elements;
receiving a query; and
providing a response to the query which gives more prominence to hyperdata datasets with higher scores.

By scoring a hyperdata dataset by accumulating a contribution for each relationship statement in another dataset which includes a reference to a resource defined in the hyperdata dataset, and having the amount of that contribution depend upon the nature of that relationship as set out in the relationship statement, the amount of said contribution being higher for more commonly used relationship elements, a score which better represents the importance of that dataset is obtained, which in turn enables responses to search queries to bring more important datasets more quickly to the attention of the query provider.

In some embodiments, the relationship statement comprises a subject resource, a predicate and an object resource, and said dataset earns said contribution only when the original definition of the object resource is in the dataset being scored.

In other words, some embodiments take no account of statements where the original definition of the subject resource part of a statement in another dataset is found in the dataset being scored. This reflects the broad observation that in most triples the predicate acts upon the object resource, rather than acting on the subject resource.

In some embodiments, said method further comprises obtaining an indication of the degree of usage of different relationship elements in said plurality of structured datasets.

The degree of usage of different relationship elements might be obtained, for example, from a dataset statistics server.

In some embodiments, said method further takes into account intrinsic features of the dataset being scored.

Examples of intrinsic features which might be taken into account include, for example, the publisher of the dataset, and the creation date of the dataset.

According to another aspect of the present invention, there is provided a method of operating a search engine to select, from a plurality of hyperdata datasets, one or more hyperdata datasets which are likely to contain information relevant to a user query, each hyperdata dataset including a plurality of statements about resources, said method comprising:

finding, in each of said hyperdata datasets, relationship statements which define a resource with reference to a resource defined in another dataset;
scoring each hyperdata dataset by accumulating contributions to a score for the hyperdata dataset, wherein the hyperdata dataset earns a contribution to its score when a relationship statement in another dataset refers to a resource defined in the hyperdata dataset being scored, wherein the amount of said contribution depends upon the nature of the relationship defined in said relationship statement;
receiving a query; and
providing a response to the query which gives more prominence to hyperdata datasets with higher scores.

By scoring a hyperdata dataset by accumulating a contribution for each relationship statement in another dataset which includes a reference to a resource defined in the hyperdata dataset, and having the amount of that contribution depend upon the nature of that relationship as set out in the relationship statement, a score which better represents the importance of that dataset is obtained, which in turn enables responses to search queries to bring more important datasets more quickly to the attention of the query provider.

There now follows, by way of example only, a description of specific embodiments of the present invention. This description is given with reference to the accompanying drawings, in which:

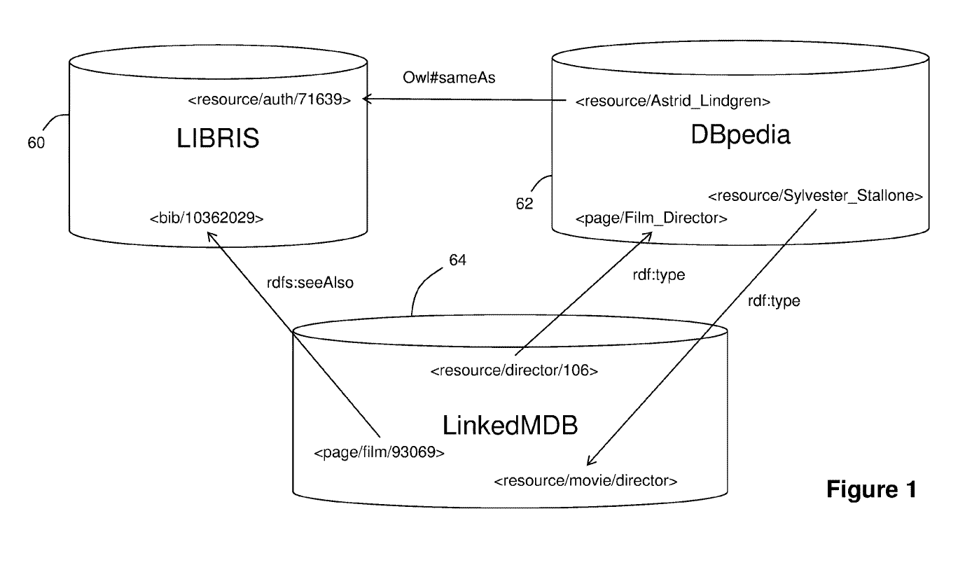

FIG. 1 illustrates inter-dataset links which might be added to existing datasets in the Linked Open Data cloud;

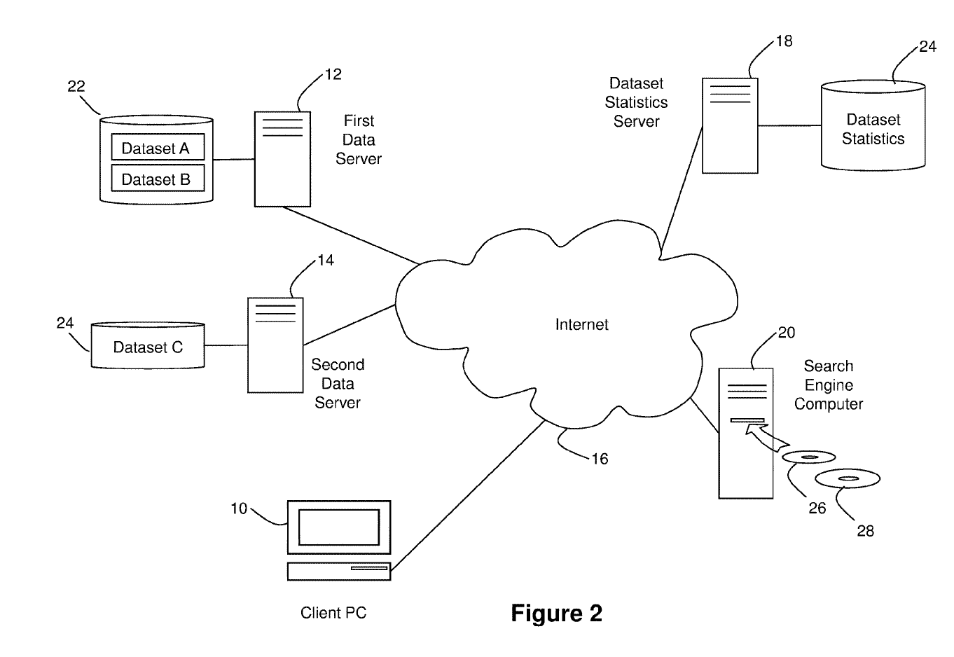

FIG. 2 shows a distributed system according to a first embodiment;

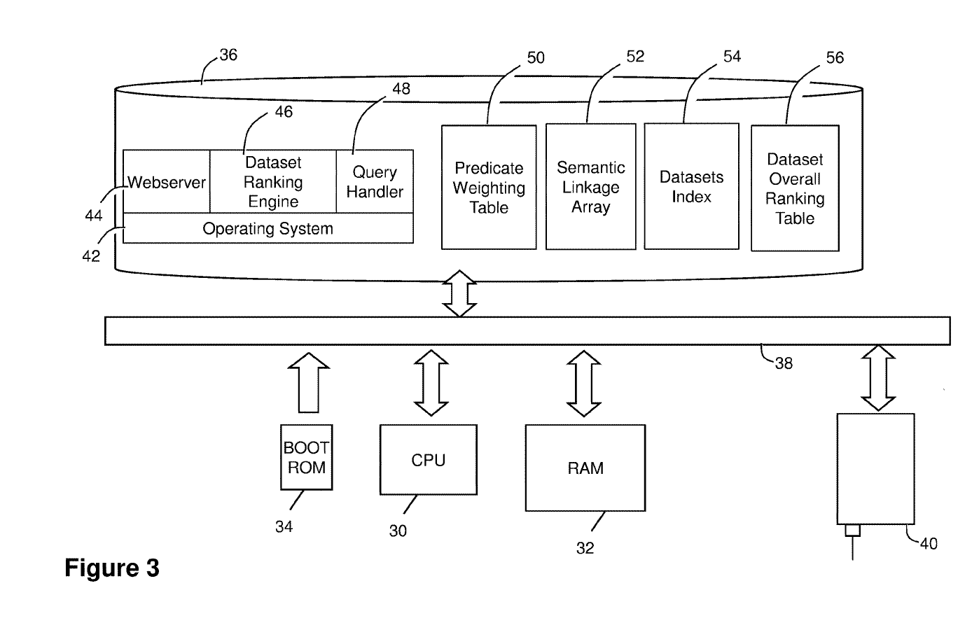

FIG. 3 shows a search engine computer included within the distributed system of FIG. 2;

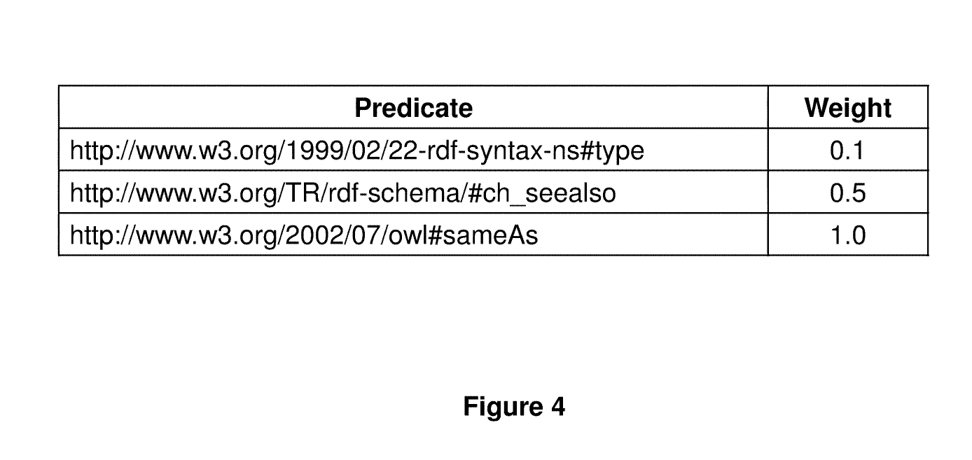

FIG. 4 shows weights assigned to different predicates to inform a subsequent dataset ranking procedure;

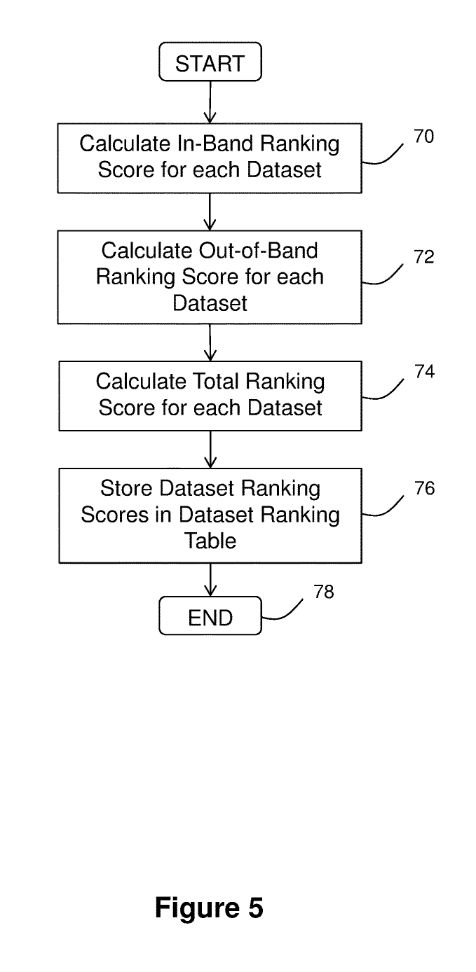

FIG. 5 shows a dataset ranking procedure carried out occasionally by the search engine computer;

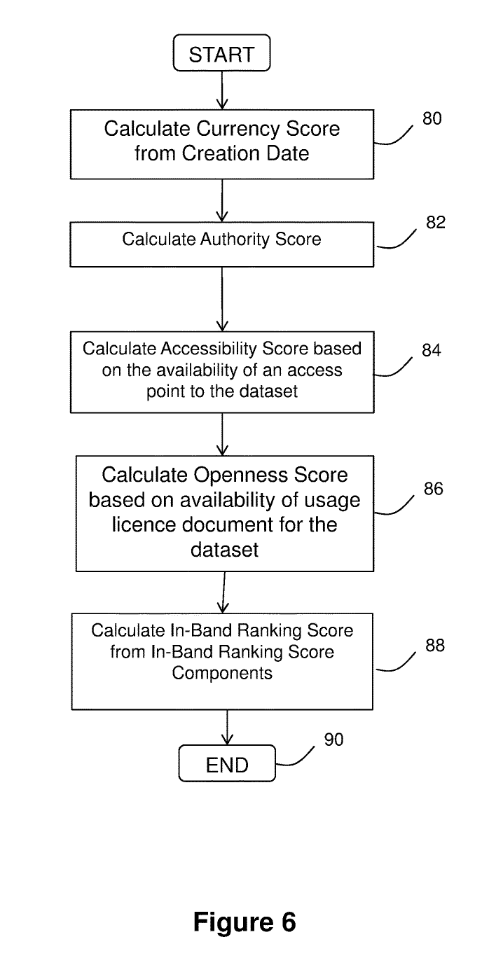

FIG. 6 shows the calculation of an in-band score for each of the datasets carried out as part of the dataset ranking procedure of FIG. 5;

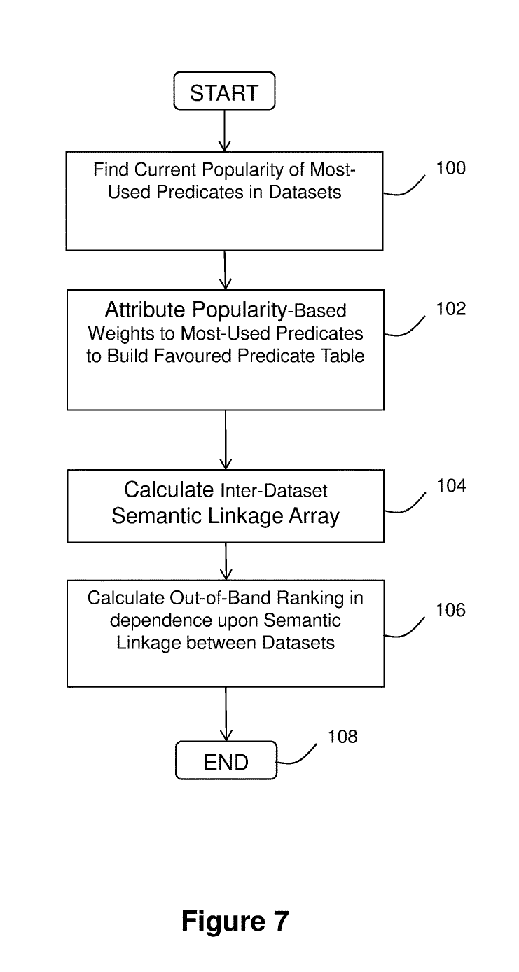

FIG. 7 shows the calculation of an out-of-band score for each of the datasets carried out as part of the dataset ranking procedure of FIG. 5;

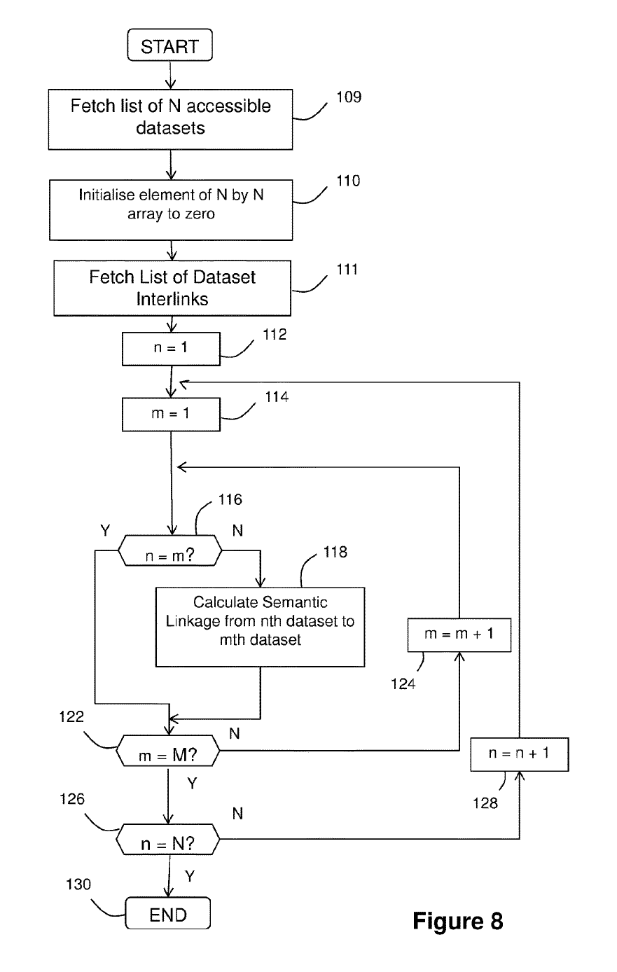

FIG. 8 shows the building of a semantic linkage array representing the semantic linkage in each direction between each pair of datasets;

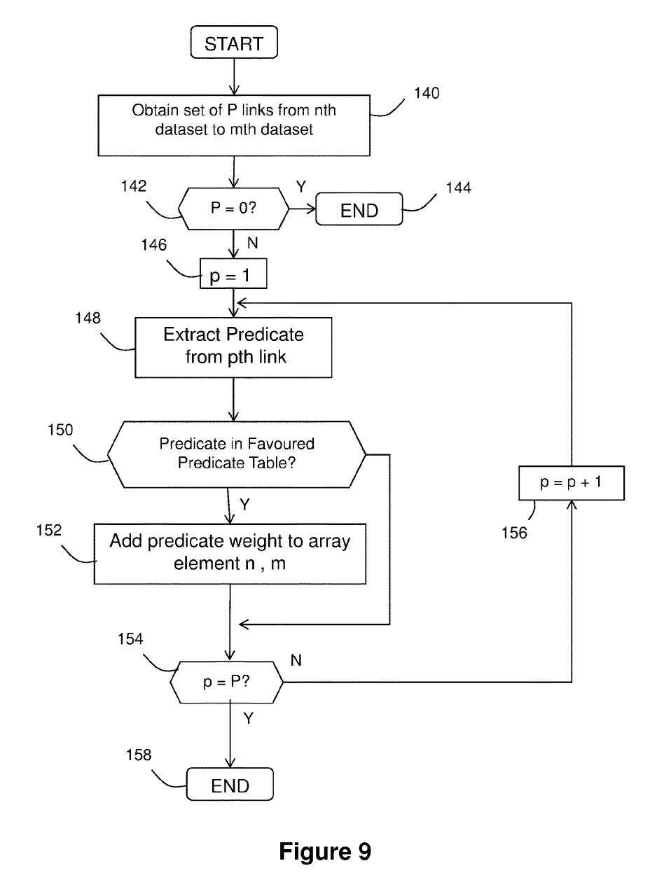

FIG. 9 shows the calculation of each element in the semantic linkage array;

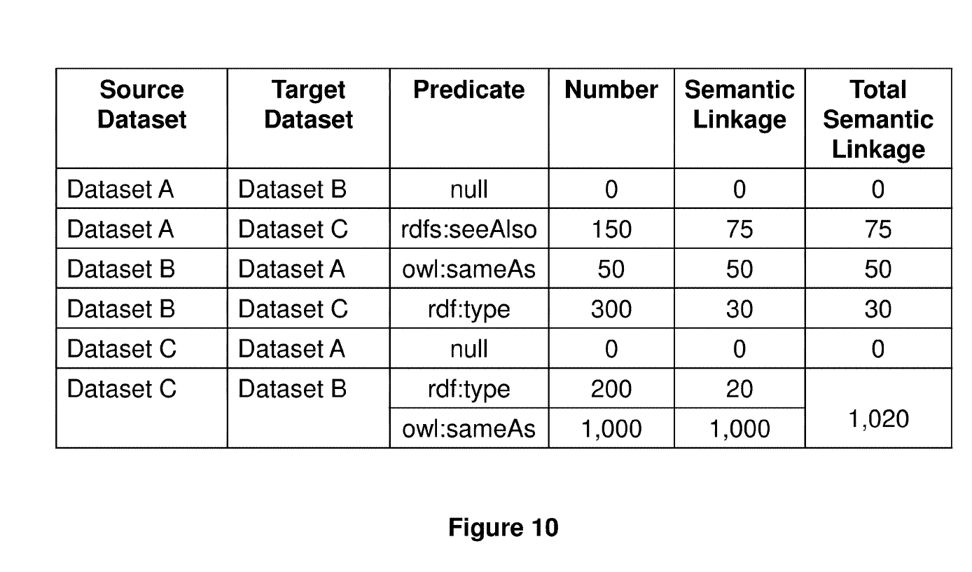

FIG. 10 shows an illustrative example of a semantic linkage array generated by the procedure of FIG. 8;

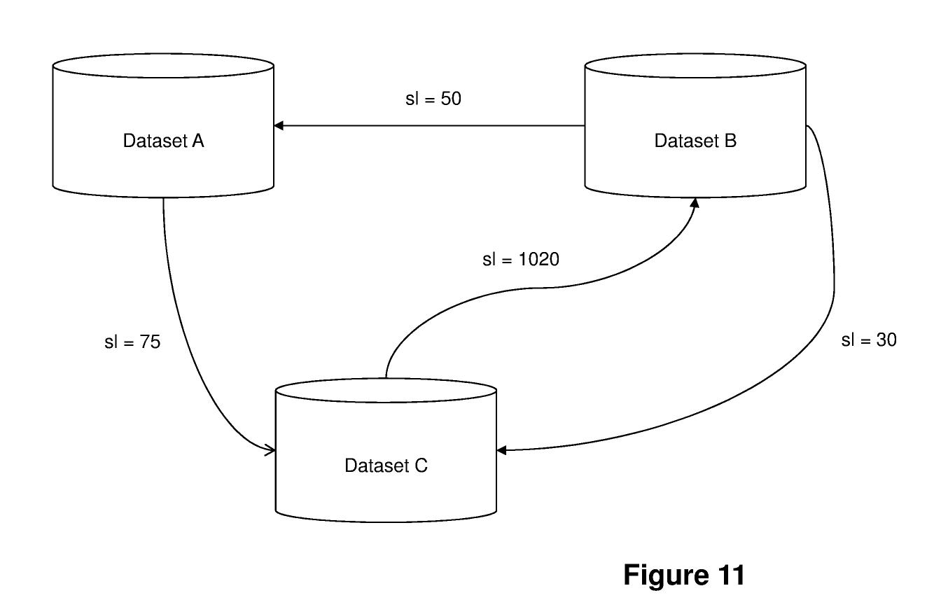

FIG. 11 shows an illustrative example of the semantic linkage between three datasets;

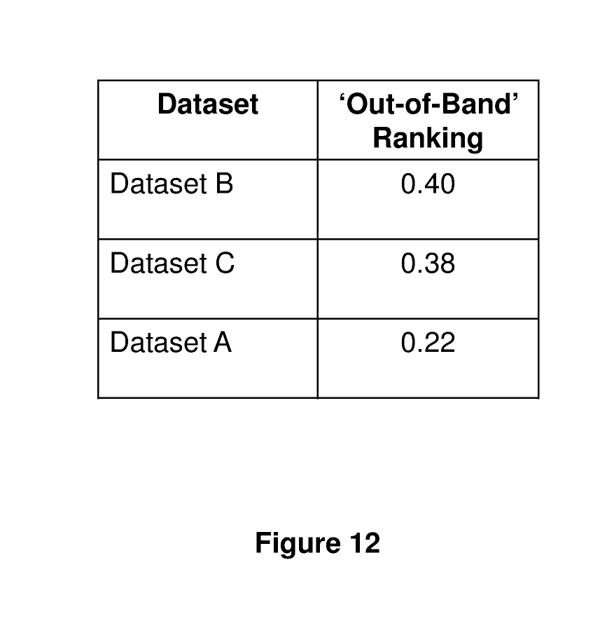

FIG. 12 shows the out-of-band dataset ranking scores which result from the linkage strengths seen in FIG. 11;

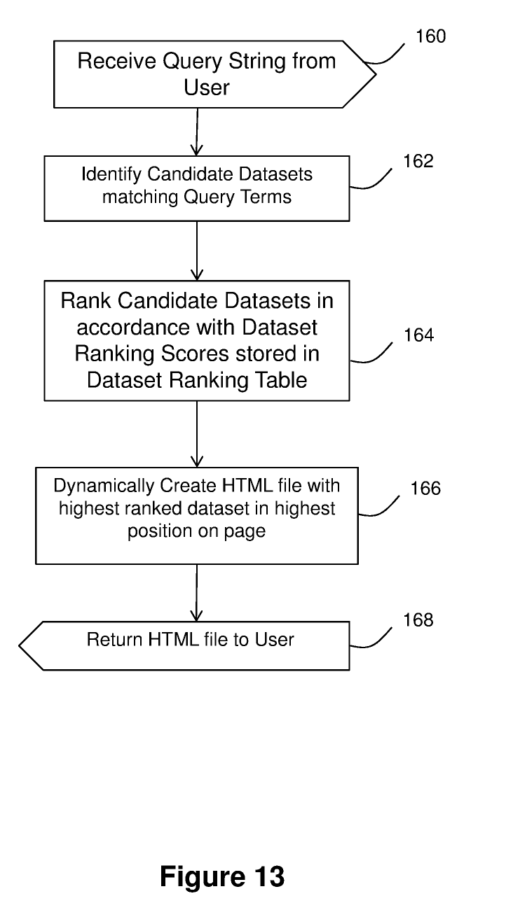

FIG. 13 is a flow-chart illustrating the handling of a query by the search engine;

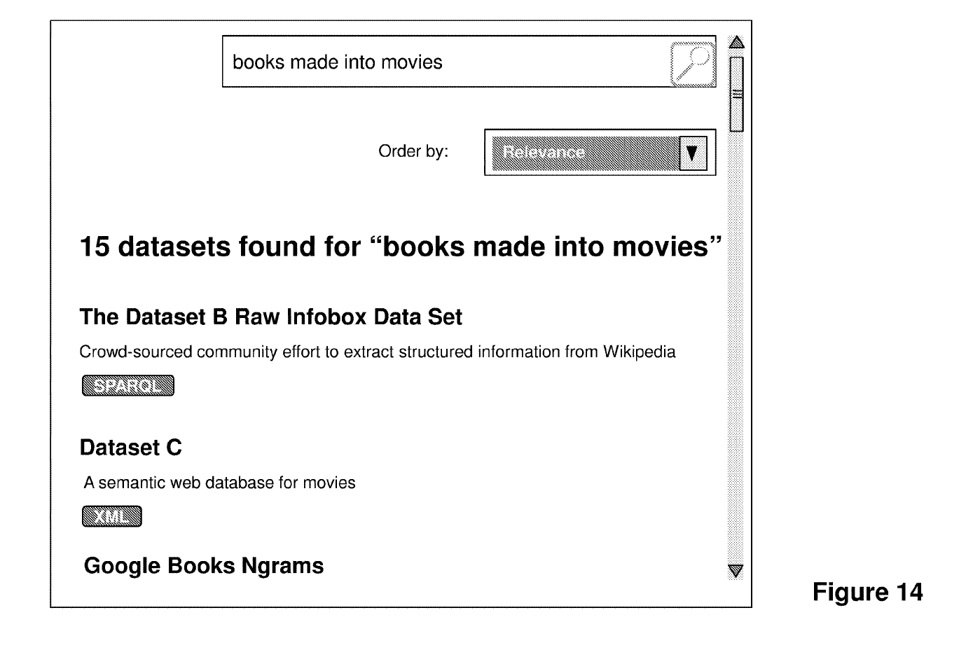

FIG. 14 is a illustration of the graphical interface presented to the user of the client personal computer in FIG. 2.

FIG. 1 is an illustrative illustration of three known datasets—namely LIBRIS 60, DBpedia 62 and LinkedMDB 64. Each of these datasets includes resource descriptions which can be arranged as RDF subject-predicate-object triples. For example, browsing the URI http://dbpedia.org/resource/Astrid_Lindgren will return a web-page listing a number of values for each of a number of properties of the author Astrid Lindgren. Each of these can be regarded as a triple in which the subject is the resource, the predicate is the property type, and the object is the value of that property type for this resource. For example, included in the file returned is the property:

http://dbpedia.org/ontology/nationality
and its associated value:
http://dbpedia.org/page/Sweden

The file can thus be considered to include the triple:

http://dbpedia.org/resource/Astrid_Lindgren, http://dbpedia.org/ontology/nationality, http://dbpedia.org/page/Sweden
(which is an indication that Astrid Lindgren is a national of Sweden)

It is possible that a property, value pair might be added to the LIBRIS dataset in which the value is a resource defined in another dataset. For example, a newly added pair might give the property:

http://www.w3.org/2002/07/owl#sameAs
a value:
http://libris.kb.se/resource/auth/71639

If this property value pair were added to the document referenced by the URI

http://dbpedia.org/resource/Astrid_Lindgren,
then, in effect, the LIBRIS dataset would be amended to include the triple:
http://dbpedia.org/resource/Astrid_Lindgren, http://www.w3.org/2002/07/owl#sameAs, http://libris.kb.se/resource/auth/71639
(which is an assertion that the two URIs refer to the same person)

A human or computer accessing the resource referenced by http://dbpedia.org/resource/Astrid_Lindgren, would then be able to go to the resource referenced by http://libris.kb.se/resource/auth/71639 to find more things about Astrid Lindgren. More generally, adding interlinks between datasets in this way increases the amount of knowledge represented on the semantic web and hence the amount of information a human or machine can discover about a resource.

Similarly, the DBpedia dataset could be amended to include the following link to the LinkedMDB dataset:

http://dbpedia.org/resource/Sylvester_Stallone, http://www.w3.org/1999/02/22-rdf-syntax-ns#type, http://data.linkedmdb.org/resource/movie/director
(which indicates that Sylvester Stallone is a movie director as that term is used in LinkedMDB)

In addition, the LinkedMDB dataset could be amended to include the following link to the DBpedia dataset:

http://data.linkedmdb.org/resource/director/106, http://www.w3.org/1999/02/22-rdf-syntax-ns#type, http://dbpedia.org/page/Film_Director
(which indicates that Richard Kelly is a film director as that term is used in DBpedia)

Finally, the LinkedMDB dataset might be amended to include the following link:

http://data.linkedmdb.org/page/film/93069, http://www.w3.org/TR/rdf-schema/#ch_seealso, http://libris.kb.se/bib/10362029
(which indicates that there is some relationship between the film ‘The Girl Who Played with Fire’ and the book ‘Flickan som lekte med elden’)

In practice, hyperdata often makes use of namespaces to allow local names to be used. To give an example, the above link might be encoded in RDF as:

```
<rdf:RDF
  xmlns: rdf = “http:///www.w3.org/TR/WD-rdf-syntax#”
  xmlns: rdfs = “http://www.w3.org/TR/rdf-schema/#”
  xmlns: mdb = “http://data.linkedmdb.org/page/film#” >
<rdf:Description about = mdb:#93069>
  < rdfs: ch_seealso >
  < http://libris.kb.se/bib/10362029 >
</rdf:Description>
</rdf:RDF>
```

Those skilled in the art will realise that the namespace definitions (i.e. the lines starting xmlns:) need only be given once in a dataset, and can thereby enable the use of local (and hence shorter) names, whilst avoiding different dataset authors or owners accidentally giving different resources defined in different datasets the same name. Often a dataset author will choose a URL of a resource (e.g. a web server) which they control, as a namespace name. The present inventors have realised that a namespace used to define a subject, predicate or object is a good indication of the author or owner of the subject, predicate or object—it can be regarded as a name for the authority responsible for defining the subject, predicate or object.

The embodiments described below take advantage of the introduction of inter-dataset links in order to provide a semantic web search engine which presents a user with a dataset relevant to his query more quickly than has been achieved up until now.

A wide-area computer network (FIG. 2) has a personal computer 10 interconnected to a first data server computer 12 and a second data server computer 14 by a communications network 16. The first data server computer 12 has persistent storage (for example a hard-disk 22), which records first and second datasets (Dataset A and Dataset B). The second data server also has persistent storage (for example a hard-disk 24), which stores a third dataset, Dataset C.

Also interconnected to one another and to the personal computer 10 and the two data servers 12,14 by the communications network 16 are a dataset statistics server computer 18 and a dataset search engine computer 20. Each is programmed to access data provided by the two data server computers 12, 14. The dataset statistics server 18 co-operates with the two data servers 12, 14 to gather statistics about the datasets—including the degree of usage of predicates within the datasets which it is configured to access (each predicate is identified by the combination of the vocabulary to which it belongs and a character string).

A dataset ranking program, whose execution will be described below with reference to FIGS. 5 to 12, is loaded from CD-ROM 26 onto the search engine computer 20. In addition, a query handler, whose execution will be described below with reference to FIGS. 13 and 14, is loaded from CD-ROM 28 onto the search engine computer 20. It will be understood by those skilled in the art that these programs might instead be loaded via a different recording device, or might be downloaded to the search engine computer 20 from a persistent store accessible via a communications network such as the Internet.

A web browser program (e.g. Internet Explorer from Microsoft Corporation), is installed on the personal computer 10.

The search engine computer 20 comprises (FIG. 3) a central processing unit 30, a volatile memory 32, a read-only memory (ROM) 34 containing a boot loader program, and writable persistent memory—in this case in the form of a hard disk 36 (other forms of persistent memory such as solid state drive could be used instead). The processor 30 is able to communicate with each of these memories via a communications bus 38.

Also communicatively coupled to the central processing unit 30 via the communications bus 38 is a network interface card 40 which provides a communications interface between the search engine computer 20 and the communications network 16.

The hard disk 36 of the search engine computer 20 stores an operating system program 42, a webserver program 44, the dataset ranking program loaded from the CD-ROM 26, and the query handler program 46 loaded from the CD-ROM 28.

Each of the server computers 12, 14, 18, comprises similar hardware as well as an operating system program and a webserver program.

The data servers 12, 14 additionally have software installed upon them which provides one or more APIs (Application Programming Interfaces) to allow the contents of the datasets they store to be accessed. One of these APIs may be a SPARQL end-point (SPARQL is a recursive acronym for SPARQL Protocol and RDF Query Language) which allows queries to be made on the dataset stored by the server computer 12, 14 and triples which satisfy these queries to be returned. The servers 12, 14 may also provide one or more URLs referencing text files which contain the datasets, perhaps in RDF/XML or nTriple format. By downloading these text files, other computers could retrieve parts or the whole of the datasets without a specific query.

The dataset statistics server 18 additionally has software installed upon it which automatically interrogates the first and second data servers 12, 14 to gather various statistics about the datasets they contain. Further software is installed on the dataset statistics server to provides one or more APIs (Application Programming Interfaces) to allow other computers (such as the search engine computer 20) to query the statistical data gathered by the dataset statistics server 18. In the present example, the statistical server 18 finds authoritative datasets accessible in the distributed system. Here, the following definition of an authoritative dataset is used:

“A dataset is authoritative with respect to a certain URI namespace if it contains information about resources named by URIs in this namespace, and is published by the URI owner”

This definition is taken from the paper “Describing linked datasets—on the design and usage of void, the Vocabulary of Interlinked Datasets (2009)”, by Keith Alexander, Michael Hausenblas in the proceedings of the Linked Data on the Web Workshop (LDOW 09).

In the present embodiment, the datasets statistics server is provided with a list of authoritative datasets, each member of that list being identified by the name of the URI namespace for which it is authoritative. However, in other embodiments, the datasets statistics server might be provided with an initial list of one or more datasets, and then follow references to other datasets in those datasets in order to gather a list of authoritative datasets.

Once the dataset statistics server has the list of authoritative datasets, it extracts triples in which the namespace of the subject differs from the namespace of the object (such triples are referred to here as interlinks). For each of the extracted triples, the dataset statistics server records the subject, the namespace of the subject, the predicate, the namespace of the predicate, the object and the namespace of the object. It then expands the predicate to include the name of the namespace to arrive at the globally unique name of the predicate (a URI in the case of Linked Data), and tallies the number of instances of each predicate in the interlinks to arrive at a count of the number of usages of each predicate in dataset interlinks. The list of datasets, set of dataset interlinks, and the ten most popular predicates in interlinks are then stored and made accessible via the API to other computers. The datasets statistics server occasionally or periodically updates the list of datasets, the set of dataset interlinks, and the ten most popular predicates.

Returning to the search engine computer (FIG. 3; 20), data structures stored on the hard disk 36 include:

i) a Predicate Weighting Table 50 (described in more detail below in relation to FIG. 4);
ii) a Semantic Linkage Array 52 (described in more detail below in relation to FIG. 10);
iii) a Datasets Index 54 which comprises an index in which datasets are indexed by keywords
iv) a Database Overall Ranking Table 56 used in selecting the one or more datasets which are to be given more prominence when generating an answer to a user's query.

Those skilled in the art will understand that many different types of data structures might be used instead of the tables and array mentioned above.

The predicate weighting table (FIG. 4) stored on the hard disk 36 of the search engine computer 20 has an entry for each of a plurality of predicates which gives a weighting to be applied to inter-dataset links including that predicate in the dataset ranking procedure which will now be described.

The dataset ranking procedure (FIG. 5) is carried out occasionally, or periodically, and begins with the calculation 70 of an ‘in-band’ component of an overall ranking score for each dataset. This ‘in-band’ component reflects intrinsic indications of the quality of the dataset. This is followed by the calculation 72 of an ‘out-of-band’ component of the overall ranking score for the dataset. The ‘out-of-band’ component reflects extrinsic indications of the quality of the dataset. The ‘in-band’ component and ‘out-of-band’ component are then combined 74 to provide an overall ranking score for the dataset. In this specific embodiment, the combination is an addition of the two scores, but alternatively the combination could be a weighted addition, or a product or some other combination of the two values. Once the overall dataset ranking score has been found it is stored 76 in the dataset overall ranking table 56. The dataset ranking procedure then ends 78.

The calculation of the in-band ranking score for each dataset (FIG. 6) begins with the calculation of five in-band ranking score components, as follows:

a) a currency score calculation 80 which involves the calculation of a currency score from a creation date of the dataset. In the present example, a value between 0 and 0.125 is assigned to the dataset, with the most current datasets being given a score at the higher end of that range.
b) an authority score calculation 82 which calculates a score depending upon whether the dataset declares the publisher of the dataset. A score of 0.125 is given in cases where the dataset does declare the publisher of the dataset, and a score of 0 is given otherwise.

For example, the score of 0.125 might be given where a dataset includes values for known properties such as the Dublin Core Metadata Terms dcterms:publisher, dcterms:creator or dcterms:contributor.

c) an accessibility score calculation 84 based on the availability of an access point to the dataset.

An access point is some sort of Application Programming Interface, a SPARQL endpoint or the URL of a file containing the dataset. If the dataset includes metadata using the Vocabulary of Interlinked Datasets (VOID) described in the paper “Describing linked datasets—on the design and usage of void, the ‘vocabulary of interlinked datasets (2009)’” by Keith Alexander, Michael Hausenblas in the proceedings of the Linked Data on the Web Workshop (LDOW 09), then credit might be given, for example, for the presence of values for the void:sparqlEndpoint, void:dataDump properties to arrive at a value in the range 0 to 0.125.

d) an openness score calculation 86 based on the availability of a usage license document for the dataset. For example, if the dataset includes metadata using VOID, then credit might be given for presence of a value for the dcterms:license property. Different scores might then be given for different licenses identified as the value of that property. The score given is in the range 0 to 0.125.

An in-band ranking score is then calculated 88 by adding together the four in-band ranking score components mentioned above to give a value between 0 and 0.5. The calculation might instead involve a weighted addition of the in-band ranking score components, the calculation of the product of one or more of the components or some other function of the four in-band ranking score components.

The calculation (FIG. 7) of an out-of-band ranking score begins by finding 100 the popularity of the most-used predicates in datasets analysable by the search engine computer 20. In the present embodiment, the search engine computer 20 uses the API provided by the dataset statistics server 18 to obtain 100 a list of the ten most-used predicates. Once that list is received 100, weights are accorded 102 to those predicates in dependence upon how frequently those predicates are used by users. There is an assumption that those generating links between datasets will tend to use predicates which they think are of most value.

The most common predicate in the interlinks between the datasets is given a score of 1.0, with the next most common being given a score of 0.9, and so on down to a score of 0.1 being given to the tenth most common predicate in the datasets. Other scoring methods which give higher scores to more frequently occurring predicates could be used instead.

Based on the weights assigned to the most common predicates, the search engine computer 20, running under the control of the database ranking engine (FIG. 3; 46), then goes on to calculate 104 an inter-dataset semantic linkage array (FIG. 10) for the datasets (A, B, C) in the distributed system (FIG. 1).

The calculation (FIG. 8) of the inter-dataset semantic linkage array begins with the downloading 109 of the list of N accessible authoritative datasets from the dataset statistics server 18. This is followed by the initialization to zero of each element of an array with as many rows, and as many columns as there are datasets accessible to the search engine computer 20. Thereafter, a complete list of dataset interlinks is fetched 111 from the dataset statistics server 18 (the program at this point using the API offered by the dataset statistics server 18). It will be remembered that this list includes the subject part of the interlink, the namespace of the subject, the predicate part of the interlink, the namespace of the predicate, the object part of the interlink and the namespace of the object.

Thereafter, an outer loop counter (n) is initialized 112 to one. An outer group of operations (114 to 128) is then carried out as many times as there are datasets (A, B, C) accessible to the search engine computer 20.

The outer group of operations (114 to 128) begins with the setting 114 of an inner loop counter (m) to one.

Thereafter, an inner group of instructions (116 to 124) is also carried out as many times as there are authoritative datasets accessible to the search engine computer 20. The inner group of instructions begins with a test 116 to establish whether the inner loop counter and outer loop counter are equal. If so, then the current execution of the inner group of instructions is skipped. If, on the other hand, the inner loop counter (m) and the outer loop counter are not equal, then the semantic linkage from the mth dataset to the nth dataset is found 118.

The calculation of the semantic linkage from the nth dataset to the mth dataset is illustrated in FIG. 9.

The process begins with the extraction 140 of the set of interlinks from the nth dataset to the mth dataset from the list downloaded from the database statistics server 18. Each datasets is identified by the name of the namespace for which it is authoritative.

A test 142 is then carried out to see if the extracted set of links is an empty set. If so, the process ends 144 (the semantic linkage is then zero, which matches the initial value given to the corresponding array element).

If the set includes one or more links, then a link counter is set 146 to one.

A loop of instructions (148 to 156) is then carried out for each of the links in the set. Each iteration of that loop of instructions begins with the extraction 148 of the predicate from the pth link in the set. A test 150 is then carried out to find whether the predicate is present in the Predicate Weighting Table 50 built earlier (FIG. 7; 102). If the predicate of the pth link is found in the Predicate Weighting Table 50, then the weight associated with that predicate is added 152 to a cumulative total representing the semantic linkage between the nth dataset and the mth dataset. If the predicate of the pth link is not found in the Predicate Weighting Table 50, then the addition step 152 is skipped. Thereafter, a test 154 is carried out to find whether the link just considered is the last link in the set. If not, then the link counter is incremented 156, and the loop of instructions (148 to 156) repeated. If the test 154 finds that the link just considered was the last link in the set, then the process ends 158.

Returning now to FIG. 8, following the calculation of the semantic linkage from the nth to the mth dataset, an inner loop termination test 122 is carried out to see whether the mth dataset is the last of the datasets accessible to the search engine computer 20. If it is not then inner loop counter m is incremented 124 and the inner group of instructions (116 to 122) is repeated.

When the inner loop termination test 122 finds that the last dataset has been considered, an outer loop termination test 126 is then carried out.

The outer loop termination test 126 finds whether the outer loop counter is equal to the number of datasets accessible to the search engine computer 20. If the loop counter is not yet equal to the number of datasets accessible to the search engine computer 20, then the outer loop counter n is incremented 128 by one and the outer group of instructions (114 to 126) is repeated for the next dataset in the list of N accessible authoritative datasets.

When the loop counter does reach the number of datasets accessible to the search engine computer 20, then the calculation of the Inter-Dataset Semantic Linkage Array ends.

Returning then to FIG. 7, the values in the semantic linkage array are then used to calculate an out-of-band ranking for the datasets.

In this embodiment, the calculation accords with a rational random surfer model, in which a random surfer is assumed to start with equal probability at any one of the datasets, and then moves to another dataset with a probability proportional to the calculated semantic linkage from the dataset he is currently at to each of the datasets to which he might move. For example, if the random surfer were at Dataset B in FIG. 11, then at the next step he might move to Dataset C with a probability equal to:

$$probability = \frac{semantic linkage from B to C}{total semantic linkage from B} = 0.325$$

After a given number of steps, there will be a calculable probability that the rational random surfer is at any given dataset. These probabilities will tend towards fixed values as the number of steps taken increases. One algorithm able to calculate these probabilities is the iterative algorithm presented in section 2.6 of the paper “The PageRank Citation Ranking: Bringing Order to the Web”, Jan. 29, 1998 by Lawrence Page, Sergey Brin and others.

Running that algorithm on the semantic linkages shown in FIG. 11 leads to the out-of-band ranking values seen in FIG. 12.

Returning once again to FIG. 7, the out-of-band ranking calculation then ends. Control returns to FIG. 5, where the in-band ranking score and out-of-band ranking score are added together 74 to arrive at a total ranking score for each dataset. The ranking scores thus calculated are then stored 76 in the Dataset Overall Ranking Table (FIG. 3; 56).

The subsequent handling of a user query (FIG. 13) begins with the search engine computer 20 receiving 160 a query string—in this case one or more words—from a user.

The query engine then uses the Datasets Index (FIG. 2; 54) to find datasets whose characteristic words match the words in the query (characteristic meaning that the words are more commonly found in the dataset in question than they are found in the datasets accessible to the search engine computer 20 in general).

The best matching datasets are then ordered 164 in accordance with the Dataset Overall Ranking Table. Thereafter, an HTML file is generated 166 in which when rendered by the Client PC 10 causes the Client PC to present on its display higher ranking datasets amongst the matching datasets more prominently than lower ranking datasets amongst the matching datasets (for example by placing them at the top of a list to be presented on the screen of the Client PC 10).

Finally, the dynamically generated HTML file is returned 168 to the client PC. The interface presented to the user might then appear as shown in FIG. 14. It will be seen how Dataset B is presented at the top of the list owing to it having the highest overall dataset ranking.

Many variations might be made to the above embodiment—these include (this list is by no means exhaustive):

i) whilst in the above embodiment, relationship statements are represented as subject-predicate-object triples (in accordance with the Resource Description Framework data model), they might be expressed in other ways, for example, in a first-order logic representation such as relationship (item A, item B). Furthermore, relationship statements might include further information—and hence might take the form of a quadruple, quintuple etc.
ii) in the above embodiment, the query provider is a human interacting with the search engine via a graphical user interface. However in other embodiments, the query provider could be a software agent or application;
iii) A dataset can be a file, a collection of files, or all files in a given domain (but are a collection of information about a plurality of resources). As the term is used here, resources do not include predicates—they correspond to constants in first-order logic;
iv) whilst in the above embodiment, the search engine computer carried out the dataset ranking procedure, in alternative embodiments, the dataset ranking might be carried out by a different computer and the results of that ranking passed to a computer which uses that ranking in generating a search result to be provided to the user. To give a particular example, the dataset statistics server computer 18 could carry out the dataset ranking;
v) in the above embodiment, the weight attributed to the predicate depended on the entire predicate. However, in other embodiments, the weight might depend upon only the vocabulary part (i.e. the part before the # symbol in each row of FIG. 4).
vi) various of the steps performed in the above method could be grouped differently and run at different times. For example, the calculation (FIG. 7, steps 100 and 102) of the popularity of predicates in the datasets analysable by the search engine computer might be carried out relatively infrequently—e.g. on a monthly basis. The calculation of the inter-dataset semantic linkage array could be carried out more frequently—perhaps weekly. Similarly, the frequency of the calculation of the in-band ranking score could be performed at a different frequency from the calculation of the inter-dataset semantic linkage and the calculation of the in-band ranking score;
vii) whilst the above example included two data servers, one of which stored two datasets, and the other of which stored a single dataset, other embodiments might include a much greater number of data servers, with one or more of those data servers storing more than two, perhaps considerably more than two, datasets;
viii) whilst the above description refers to Uniform Resource Identifiers, this should be taken to extend to Internationalized Resource Identifiers;
ix) whilst in the above embodiment, the dataset statistics server tallied the usage of predicates in interlinks, it might instead tally the usage of predicates in datasets in general, and use that measure (instead of the usage of predicates in interlinks) as an input to the semantic linkage calculation;
x) the weights given in the above example are merely for the purposes of illustration, and could be of course be varied;
xi) in addition to the in-band scores mentioned above, a dataset could be given a score based upon its reliability, e.g. uptime, response time etc;
xii) in some embodiments, account might be taken of the URL at which the dataset is hosted. If the dataset is hosted in a given domain, then that could be taken as an indication that the authority that owns that domain gives credence to that dataset. Hence, datasets which are hosted in predetermined domains might be given a higher in-band ranking score. Conversely, if a dataset is hosted in an untrusted or blacklisted domain, that dataset might be given a lower in-band ranking score, or even be given a low or zero overall ranking score.

In summary of the above disclosure, a dataset ranking procedure for use in a hyperdata search engine is disclosed. A problem with known hyperdata search engines is they rank the datasets in a way that leads to prominence being given in search results to unimportant datasets. The hyperdata search engine disclosed here addresses this problem by giving extra credence to any dataset which includes the original definition of a resource which is referred to in a resource definition in another dataset. In this way, datasets which the authors of other datasets choose to refer to in their own resource definitions are given greater prominence in the results provided by a hyperdata search engine, providing a user with what he requires in order to more quickly find a dataset which provides useful information relating to his search query. In some embodiments, the reference to another dataset is found in a relationship statement including a subject, predicate and object, and the amount of extra credence given by virtue of the reference depends on the predicate found in the relationship statement. In refinements of those embodiments, the use of a more popular predicate in the relationship statements leads to the reference being given more weight.

1. A method of operating a search engine to select, from a plurality of hyperdata datasets, one or more hyperdata datasets which are likely to contain information relevant to a user query, each hyperdata dataset including a plurality of statements about resources, said method comprising:
finding, in each of said hyperdata datasets, relationship statements which define a resource with reference to another resource defined in another dataset, said relationship statements including a relationship element indicative of the nature of the relationship between said resource and said other resource;
scoring each hyperdata dataset by accumulating contributions to a score for the hyperdata dataset, wherein the hyperdata dataset earns a contribution to its score when a relationship statement in another dataset refers to a resource defined in the hyperdata dataset being scored, wherein the amount of said contribution depends upon the relationship element in said relationship statement, said contribution being higher for more commonly used relationship elements;
receiving a query; and
providing a response to the query which gives more prominence to hyperdata datasets with higher scores.

2. A method according to claim 1 in which said relationship statement comprises a subject resource, a relationship element comprising a predicate and an object resource, and said dataset earns said contribution only when the original definition of the object resource is in the dataset being scored.

3. A method according to claim 1 further comprising: obtaining an indication of the degree of usage of different relationship elements in said plurality of structured datasets.

4. A method according to claim 1 wherein said relationship element comprises a predicate and an ontology in which said predicate is defined.

5. A method according to claim 4 further comprising obtaining an indication of the degree of usage of the ontology in which said predicate is defined, and setting the amount of said contribution higher for relationship elements which are defined in more commonly used ontologies.

6. A method according to claim 1 which further takes into account intrinsic features of the dataset being scored.

7. A computer-implemented search engine comprising:
a communications port adapted to receive:
i) a plurality of hyperdata datasets, each hyperdata dataset including a plurality of statements about resources;
ii) a search query from a search engine user;
a processor arranged in operation to:
a) find, in each of said hyperdata datasets, relationship statements which define a resource with reference to another resource defined in another dataset, said relationship statements including a relationship element indicative of the nature of the relationship between said resource and said other resource;
b) score each hyperdata dataset by, for each of said relationship statements from another dataset which refer to a resource defined in the hyperdata dataset being scored, adding a contribution to a score for the hyperdata dataset, the amount of said contribution depending upon the relationship element in said relationship statement, said contribution being higher for more commonly used relationship elements;
c) receive said search query; and
d) generate a search result which gives more prominence to hyperdata datasets with higher scores;
a communications port adapted to send said search result to said search engine user.

8. A computer program executable by a processor to perform a method according to claim 1.

9. A computer readable medium embodying a computer program according to claim 8.
